(19) United States
(12) Patent Application Publication
(10) Pub. No.: US 2026/0346838 A1
(43) Pub. Date: Nov. 5, 2026

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Yuma Watanabe, Tokyo (JP)

(21) Appl. No.: 19/546,468

(22) Filed: Feb. 23, 2026

(30) Foreign Application Priority Data
Feb. 28, 2025 (JP) 2025-032106

(51) Int. Cl. B60W 30/09; G06V 20/59

(52) U.S. Cl. CPC B60W 30/09; G06V 20/597

(57) ABSTRACT

A driving assistance device includes a surrounding information acquisition part configured to acquire surrounding information of a host vehicle, a traffic light information acquisition part configured to acquire positional information and lighting status of traffic lights present around the host vehicle on the basis of positional information of the host vehicle, and a driving assistance part configured to perform driving assistance of the host vehicle on the basis of the acquisition results of the surrounding information acquisition part and the traffic light information acquisition part, the driving assistance part suppressing acceleration of the host vehicle when a distance from the host vehicle to the traffic lights in a course of a lane in which the host vehicle is traveling is less than a predetermined distance, and the traffic light information acquisition part has not acquired information on lit color of the traffic lights.

### CROSS-REFERENCE TO RELATED APPLICATION

Priority is claimed on Japanese Patent Application No. 2025-032106, filed Feb. 28, 2025, the content of which is incorporated herein by reference.

### BACKGROUND OF THE INVENTION

### Field of the Invention

The present invention relates to a driving assistance device, a driving assistance method, and a storage medium.

### Description of Related Art

In recent years, among transportation participants, efforts to provide access to sustainable transportation systems that take into consideration vulnerable people are gaining momentum. To achieve this, research and development into driving assistance technology is being focused on to further improve traffic safety and convenience. In relation to this, in recent years, known technologies include controlling alarm output on the basis of the combination of light colors of a plurality of traffic lights when the plurality of traffic lights are recognized, decelerating a vehicle when a permitted direction of travel of an arrow signal differs from an intended direction of travel of the vehicle, and controlling a vehicle in an autonomous mode on the basis of the reliability of traffic signals (for example, see Japanese Unexamined Patent Application, First Publication No. 2023-112545, Japanese Patent Publication No. 2015-518600, Japanese Unexamined Patent Application, First Publication No. 2021-76899).

### SUMMARY OF THE INVENTION

Incidentally, in the driving assistance technology in the related art, there are several possible situations in which the lit color of traffic lights may become indefinite, but there has been an issue in that appropriate speed control and other driving assistance may not be available for each of these possible situations.

An aspect of the present application is directed to providing a driving assistance device, a driving assistance method, and a storage medium capable of performing more appropriate driving assistance according to an acquisition status of information related to traffic lights. An aspect of the present application is directed to contributing to development of a sustainable transportation system.

A driving assistance device, a driving assistance method, and a storage medium according to the present invention employ the following configurations.
(1) A driving assistance device according to an aspect of the present invention is a driving assistance device including: a storage medium storing computer-readable instructions; and at least one processor connected to the storage medium, wherein the processor executes the computer-readable instructions to: acquire surrounding information of a host vehicle; acquire positional information and lighting status of traffic lights present around the host vehicle on the basis of positional information of the host vehicle; perform driving assistance of the host vehicle on the basis of the acquired information, and suppresses acceleration of the host vehicle when a distance from the host vehicle to the traffic lights in a course of a lane in which the host vehicle is traveling is less than a predetermined distance, and information on lit color of the traffic lights has not been acquired.
(2) In the aspect of the above-mentioned (1), the processor executes the computer-readable instructions to: detect a driving operation by a driver of the host vehicle, and suppress acceleration of the host vehicle due to the driver's acceleration operation when the distance from the lane to the traffic lights in the course of the lane in which the host vehicle is traveling is less than the predetermined distance and information on the lit color of the traffic lights has not been acquired.
(3) In the aspect of the above-mentioned (2), the case where the lit color of the traffic lights has not been acquired includes a period from when existence of the traffic lights is acquired based on the acquired information until when information on the lit color of the traffic lights has been acquired.
(4) In the aspect of the above-mentioned (2), the processor executes the computer-readable instructions to: suppress acceleration of the host vehicle when it is unable to acquire information on the lit color of the traffic lights after acquiring that the lit color of the traffic lights is blue.
(5) In the aspect of the above-mentioned (2), the processor executes the computer-readable instructions to: decelerate the host vehicle when it is unable to acquire information on the lit color of the traffic lights after acquiring that the lit color of the traffic lights is red or yellow.
(6) In the aspect of the above-mentioned (5), the processor executes the computer-readable instructions to: perform at least one of notification to the driver and deceleration of the host vehicle when it is acquired that the traffic lights are lit in yellow or red, and acquire that the driver's deceleration operation has not been detected or the degree of deceleration operation is less than a threshold.
(7) In the aspect of the above-mentioned (1), the processor executes the computer-readable instructions to: not suppress the acceleration of the host vehicle when a speed of the host vehicle is less than a predetermined speed.
(8) In the aspect of the above-mentioned (1), the processor executes the computer-readable instructions to: not suppress the acceleration of the host vehicle when information on a following vehicle around the host vehicle is acquired.
(9) In the aspect of the above-mentioned (1), the processor executes the computer-readable instructions to: detect the driver's state of the host vehicle, not suppress the acceleration of the host vehicle when it is detected that the driver is in a state where the driver is monitoring the front.
(10) In the aspect of the above-mentioned (1), the processor executes the computer-readable instructions to: not suppress acceleration of the host vehicle when it is acquired that there is an adjacent lane adjacent to the lane in which the host vehicle is traveling and able to travel in the same direction as the lane, and there is another vehicle passing through an intersection where the traffic lights are installed in the adjacent lane.
(11) In the aspect of the above-mentioned (1), the processor executes the computer-readable instructions to: acquire information on the lit color of the traffic lights based on an image captured by a camera installed in the host vehicle or information received by a communication device that communicates with the traffic lights.
(12) A driving assistance method according to another aspect of the present invention is a driving assistance method of causing a computer to: acquire surrounding information of a host vehicle; acquire positional information and lighting status of traffic lights present around the host vehicle on the basis of positional information of the host vehicle; perform driving assistance of the host vehicle on the basis of the acquired information; and suppress acceleration of the host vehicle when a distance from the host vehicle to the traffic lights in a course of a lane in which the host vehicle is traveling is less than a predetermined distance, and information on lit color of the traffic lights has not been acquired.
(13) A storage medium according to another aspect of the present invention is a computer-readable non-transient storage medium, on which a program is stored, causing a computer to: acquire surrounding information of a host vehicle; acquire positional information and lighting status of traffic lights present around the host vehicle on the basis of positional information of the host vehicle; perform driving assistance of the host vehicle on the basis of the acquired information; and suppress acceleration of the host vehicle when a distance from the host vehicle to the traffic lights in a course of a lane in which the host vehicle is traveling is less than a predetermined distance, and information on lit color of the traffic lights has not been acquired.

According to the aspects of the above-mentioned (1) to (13), it is possible to perform more appropriate driving assistance according to an acquisition status of information related to traffic lights.

### BRIEF DESCRIPTION OF THE DRAWINGS

FIG. 1 is a configuration view of a vehicle system including a driving assistance device according to an embodiment.

FIG. 2 is a view showing an example of a scene where driving assistance of the embodiment is executed.

FIG. 3 is a view showing an example of a screen where a following vehicle present around a host vehicle.

FIG. 4 is a view showing an example of a scene where the host vehicle travels on a road shape with a plurality of lanes that allow the host vehicle to travel in the same direction.

FIG. 5 is a flowchart showing an example of processing executed by a driving assistance device.

### DETAILED DESCRIPTION OF THE INVENTION

Hereinafter, embodiments of a driving assistance device, a driving assistance method, and a recording medium of the present invention will be described with reference to the accompanying drawings. Hereinafter, an example in which a driving assistance device is applied to a vehicle will be described. Further, the driving assistance device may be applied to a vehicle, as well as other moving objects such as a ship, an aircraft, or a stand-up vehicle with a power unit.

### Entire Configuration

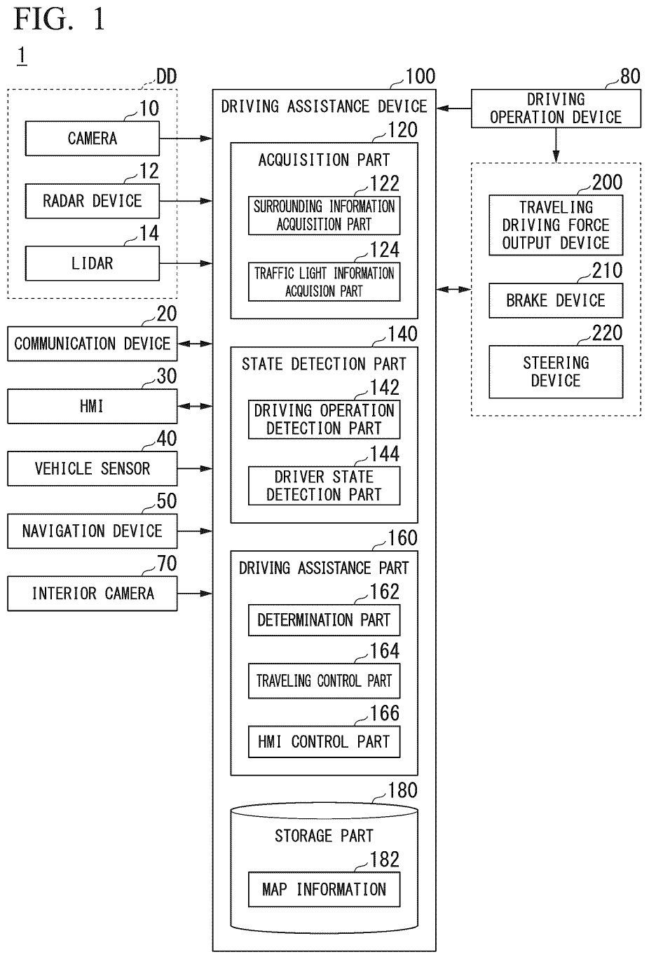

FIG. 1 is a configuration view of a vehicle system 1 including a driving assistance device according to an embodiment. A vehicle (hereinafter, referred to as a host vehicle M) in which the vehicle system 1 is mounted is, for example, a vehicle or micromobility, such as a two-wheeled, three-wheeled, or four-wheeled vehicle, and its driving source is an internal combustion engine such as a diesel engine or a gasoline engine, an electric motor, or a combination of these. The electric motor runs on power generated by a generator connected to the internal combustion engine, or on discharge power of a battery (storage battery) such as a secondary battery or a fuel cell to be used.

The vehicle system 1 includes, for example, a camera 10, a radar device 12, a light detection and ranging (LIDAR) 14, a communication device 20, a human machine interface (HMI) 30, a vehicle sensor 40, a navigation device 50, an interior camera 70, a driving operation device 80, a driving assistance device 100, a traveling driving force output device 200, a brake device 210, and a steering device 220. These devices or instruments are connected to each other by multiple communication lines such as controller area network (CAN) communication lines or the like, serial communication lines, wireless communication networks, or the like. Further, the configuration shown in FIG. 1 is merely an example, and some of the configuration may be omitted, or other configurations may be added. The camera 10, the radar device 12, or the LIDAR 14 is an example of “a detection device DD.” The HMI 30 is an example of “a notification part.”

The camera 10 is a digital camera that uses a solid-state imaging device such as a charge coupled device (CCD), a complementary metal oxide semiconductor (CMOS), or the like. The camera 10 is attached to an arbitrary location of the host vehicle M in which the vehicle system 1 is mounted. When capturing an image of the front, the camera 10 is attached to an upper portion of a front windshield, a back surface of a rearview mirror, a frontal region of the vehicle body, or the like. When capturing an image of the rear, the camera 10 is attached to an upper portion of a rear windshield, a back door, or the like. When capturing images of the sides, the cameras 10 are attached to the left and right door mirrors, or the like. The camera 10, for example, periodically captures images of the surroundings of the host vehicle M. The camera 10 may be a stereo camera.

The radar device 12 emits radio waves (radar) such as millimeter waves around the host vehicle M and detects the radio waves (reflective waves) reflected by surrounding objects to detect at least the position of the object (distance and azimuth). The radar device 12 is attached to an arbitrary location of the host vehicle M. The radar device 12 may detects the position and speed of the object using a frequency modulated continuous wave (FM-CW) method.

The LIDAR 14 irradiates surroundings of the host vehicle M with light and measures scattered light. The LIDAR 14 detects a distance to the subject based on the time between light emission and reception. The light to be irradiated is, for example, pulsed laser light. The LIDAR 14 is attached to an arbitrary location of the host vehicle M.

The communication device 20 communicates with, for example, other vehicles surrounding the host vehicle M, the terminal devices of users using the host vehicle M, or various server devices using networks such as a cellular network, a Wi-Fi network, Bluetooth (registered trademark), a dedicated short range communication (DSRC), a local area network (LAN), a wide area network (WAN), the Internet, or the like.

The HMI 30 outputs various information to occupants (including the driver) of the host vehicle M and accepts input operations from the occupants. The HMI 30 includes, for example, a display part, and a speaker. The display part is, for example, a liquid crystal display (LCD) or an organic electroluminescence (EL) display device. The display part displays various images (including video) in the embodiment. The display part may be configured integrally with an input part as a touch panel. The speaker outputs a predetermined voice (for example, an alarm sound or message audio). In addition, the HMI 30 may include a microphone, a buzzer, a touch panel, a switch, a key, and the like. The switch may include a switch that executes or terminates predetermined driving control that can be executed by a travel control part described below, or a switch that approves (allows) or rejects driving control recommendations (proposals) from the side of the system (the vehicle system 1). In addition, the switch may include a switch (turn signal switch) that performs a direction instruction operation or the like.

The vehicle sensor 40 includes a vehicle speed sensor configured to detect a speed of the host vehicle M, an acceleration sensor configured to detect acceleration, and a yaw rate sensor configured to detect a yaw rate (for example, a rotation angular speed around a vertical axis passing through a center of gravity of the host vehicle M). In addition, the vehicle sensor 40 may include a steering angle sensor configured to detect a steering angle (may be an angle of a steering handle, or an operation angle of a steering wheel) of the host vehicle M, a steering angle speed sensor configured to detect a steering angle speed, an azimuth sensor configured to detect an orientation of the host vehicle M, and the like.

In addition, the vehicle sensor 40 may include a position sensor configured to detect a position of the host vehicle M. The position sensor is a sensor configured to acquire position information (longitude/latitude information) from, for example, a global positioning system (GPS) device. In addition, the position sensor may be a sensor configured to acquire position information using, for example, a global navigation satellite system (GNSS) receiver of the navigation device 50. The vehicle sensor 40 may derive the speed of the host vehicle M from the difference (i.e., distance) of position information at predetermined times in the position sensor. The results detected by the vehicle sensor 40 are output to the driving assistance device 100.

The navigation device 50 includes, for example, a GNSS receiver, a navigation HMI, and a route determination part. The navigation device 50 may hold map information in a storage device such as a hard disk drive (HDD), a flash memory, or the like, or may acquire map information 182 stored in a storage part 180 described below.

The GNSS receiver determines the position of the host vehicle M based on the signals received from the GNSS satellites. The position of the host vehicle M may be determined or supplemented by an inertial navigation system (INS) using the output of the vehicle sensor 40. The navigation HMI includes a display device, a speaker, a touch panel, a key, and the like. The GNSS receiver may be provided in the vehicle sensor 40. The navigation HMI may be partially or entirely shared with the HMI 30 described above. The route determination part determines the route (hereinafter referred to as the route on map) from the position of the host vehicle M determined by the GNSS receiver (or an input arbitrary position) to the destination input by the occupant using the navigation HMI, for example, by referring to the map information 182, etc. In addition, the navigation device 50 performs route guidance using the navigation HMI on the basis of the determined route on map. In addition, the navigation device 50 may transmit its current position and destination to the navigation server via the communication device 20 and obtain a route equivalent to the route on map from the navigation server.

Here, the map information 182 is, for example, information that represents the road shape using links that indicate the road (an example of a travel route) and nodes connected by the links. The map information 182 may include point of interest (POI) information, and the like. In addition, the map information 182 includes, for example, the number of lanes, types or shapes of road markings (hereinafter, referred to as markings), lane center information, or road boundary information. The map information 182 may also include information related to whether the road boundaries are boundaries (physical boundaries) that include structures that the host vehicle cannot pass through (including cross or collide with). The physical boundaries are, for example, guardrails, curbs, medians, fences, and walls. In addition, the map information 182 may include road shape information, traffic regulation information, address information (address and zip code), information regarding the location and type of traffic lights (hereinafter referred to as traffic lights), positional information of crosswalks, facility information, parking information, telephone number information, etc. The road shape information is information such as a curvature (may be a radius of curvature), a width, a road gradient, a branching point, a junction, an intersection (also including a T-junction or the like), and the like, of the road. The map information 182 may be updated (renewed) at any time by the communication device 20 communicating with an external device.

The interior camera 70 is a digital camera that uses a solid-state imaging device such as a CCD, a CMOS, or the like. The interior camera 70 is attached to an arbitrary location in the host vehicle M at a position and orientation that allows it to capture an image of the head of the driver seated in the driver's seat of the host vehicle M from the front. For example, the interior camera 70 is attached to the vicinity (for example, an upper or lower portion) of the display device provided at a central portion of an instrument panel of the host vehicle M. In addition, the interior camera 70 may capture images of the interior of the region an occupant (passenger) seated in the front passenger seat of the other vehicle M of the driver. The interior camera 70, for example, periodically and repeatedly captures images of the interior of the vehicle.

The driving operation device 80 includes, for example, a steering wheel, an accelerator pedal, and a brake pedal. In addition, the driving operation device 80 may include a shift lever, an irregular steer, a joystick, and other operation devices. Each operation device of the driving operation device 80 is equipped with an operation detection part that detects, for example, the amount of operation of the operation device by the driver or whether or not the operation is being performed. The operation detection part detects, for example, a steering angle of the steering wheel, steering torque (for example, a steering amount (steering input torque) due to the driver's driving operation), a steering torque change rate, and pedaling amounts of an accelerator pedal and a brake pedal. Then, the operation detection part outputs the detection results to the driving assistance device 100, or to one or both of the traveling driving force output device 200, the brake device 210, and the steering device 220. In addition, the driving operation device 80 may include a direction indicating operation part (for example, a turn signal lever or a turn signal switch). When the direction indicating operation part is operated, the turn signal (direction indicator) of the host vehicle M associated with the operation contents flashes (blinks), and the operation contents (for example, including the detection result of the operation by the driver) are output to the driving assistance device 100.

The driving assistance device 100 executes various controls for supporting driving by the driver of the host vehicle M and driving control during execution. The driving assistance device 100 includes, for example, an acquisition part 120, a state detection part 140, a driving assistance part 160, and the storage part 180. Each of the acquisition part 120, the state detection part 140, and the driving assistance part 160 is realized by executing a program (software) using a hardware processor such as a central processing unit (CPU) or the like. In addition, some or all of these components may be realized by hardware (circuit part; including circuitry) such as a large scale integration (LSI), an application specific integrated circuit (ASIC), a field-programmable gate array (FPGA), a graphics processing unit (GPU), a system on chip (SOC), or the like, or may be realized by cooperation of software and hardware. The above-mentioned program may be stored in a storage device (a storage device including a non-transient storage medium) such as an HDD, a flash memory, or the like, of the driving assistance device 100 in advance, stored in a detachable storage medium such as a DVD, a CD-ROM, a memory card, or the like, or installed in a storage device of the driving assistance device 100 by mounting the storage medium (non-transient storage medium) in a drive device or a card slot. An HMI control part 166 is an example of “the notification control part.”

The storage part 180 may be realized by the above-mentioned storage devices, an electrically erasable programmable read-only memory (EEPROM), a read-only memory (ROM), a random access memory (RAM), or the like. The storage part 180 stores, for example, the map information 182, programs, various types of other information in the embodiment, or the like. In addition, the storage part 180 may store various types of setting information used in processing in this embodiment.

The acquisition part 120 acquires, for example, various types of information from the detection device DD, the communication device 20, the HMI 30, the vehicle sensor 40, the navigation device 50, the interior camera 70, the driving operation device 80, the traveling driving force output device 200, the brake device 210, the steering device 220, and the like. The acquisition part 120 includes, for example, a surrounding information acquisition part 122, and a traffic light information acquisition part 124.

The surrounding information acquisition part 122 acquires surrounding information of the host vehicle M based on, for example, the detection results of the detection device DD (information input from the camera 10, the radar device 12, and the LIDAR 14). For example, the surrounding information acquisition part 122 performs sensor fusion processing on the detection results from some or all of the camera 10, the radar device 12, and the LIDAR 14 to acquire state such as the position (relative position), speed (relative speed), acceleration, and shape of objects present around the host vehicle M (within a predetermined distance from the host vehicle M). The objects acquired by the surrounding information acquisition part 122 may include, for example, transportation participants such as other vehicles, pedestrians, bicycles. The other vehicles include, for example, surrounding vehicles on the road such as preceding vehicles traveling in front of the host vehicle M, following vehicles traveling behind the host vehicle M, adjacent vehicles, oncoming vehicles, stopped vehicles.

The position of the object is recognized as a position on absolute coordinates with the representative point of the host vehicle M (center of gravity, center of drive shaft, etc.) as the origin, and is used for control. The position of the object may be expressed by a representative point such as the center of gravity or a corner of the object, or by a represented area. The “state” of the object may, for example, when the object is another vehicle, include the other vehicle's acceleration or jerk, or its “behavioral state” (for example, whether the other vehicle is changing lanes or about to do so).

In addition, the surrounding information acquisition part 122 may recognize, for example, intersections (including T-junctions), crosswalks, stop lines, toll booths, other road events, road signs, and markings painted on the road (for example, speed limits).

In addition, the surrounding information acquisition part 122 recognizes the lane in which the host vehicle M is traveling (traveling lane) and other surrounding lanes (for example, adjacent lanes and oncoming lanes) based on the detection results of the detection device DD or the map information 182. For example, the surrounding information acquisition part 122 recognizes markings from the image captured by the camera 10 and recognizes traveling lanes, adjacent lanes, etc. based on the positional relationship of the recognized markings as seen from the host vehicle M. In addition, the surrounding information acquisition part 122 recognizes the traveling lane, adjacent lane, markings, etc. of the host vehicle M by referring to the map information 182 based on the positional information of the host vehicle M acquired from the vehicle sensor 40, etc. In addition, the surrounding information acquisition part 122 may recognize road boundaries instead of the markings and recognize the traveling lane and other lanes of the host vehicle M based on the recognition results. In addition, the surrounding information acquisition part 122 may acquire the location and type of traffic lights, the location of intersections and crosswalks, etc., present around the host vehicle M from the map information 182.

In addition, the surrounding information acquisition part 122 may recognize the horizontal position (position in the lane width direction) of the host vehicle M relative to the traveling lane and the attitude (orientation) of the host vehicle M relative to the direction of extension of the traveling lane based on the positional relationship of the host vehicle M to the traveling lane. For example, the surrounding information acquisition part 122 may recognize the deviation of the reference point of the host vehicle M from the lane center and the angle of the direction of advance of the host vehicle M with respect to a line connecting the lane centers as the relative position and attitude of the host vehicle M with respect to the traveling lane. Alternatively, the surrounding information acquisition part 122 may recognize the position of the reference point of the host vehicle M relative to any side end portion (markings or road boundaries) of the traveling lane as the relative position (horizontal position) of the host vehicle M relative to the traveling lane. In addition, the surrounding information acquisition part 122 may recognize the traveling trajectory of other vehicles (for example, preceding vehicles, following vehicles, adjacent vehicles, etc.) based on the detection results of the detection device DD, and may also recognize future predicted trajectories based on the traveling trajectory.

Based on the positional information of the host vehicle M, the traffic light information acquisition part 124 acquires the positional information of the traffic lights present around the host vehicle M and the lighting status including information related to the color of the lights (lighting parts) installed in the traffic lights that are lit (including flashing). For example, the traffic light information acquisition part 124 performs known image analysis processing (for example, feature extraction of edges, shape, size, and color, matching processing such as pattern matching, etc.) on the image captured by the camera 10 (hereinafter referred to as the camera image), and obtains the positions of the traffic lights present in the direction of advance of (ahead from) the host vehicle M based on the image analysis results. In addition, the traffic light information acquisition part 124 may acquire the positions of the traffic lights present in the direction of advance of the host vehicle M based on the output results of the radar device 12 or the LIDAR 14. Further, the traffic light information acquisition part 124 may refer to the map information 182 based on the positional information of the host vehicle M and acquire information regarding the location and type of the traffic lights present in the direction of advance of the host vehicle M.

In addition, when traffic lights are present around the host vehicle M, the traffic light information acquisition part 124 acquires information related to the color in which the lamps (lighting parts) installed in of the traffic lights are lit (or flashing) (hereinafter sometimes referred to as “the color in which the traffic lights are lit”) based on the image analysis results (for example, color features) of the camera image. In addition, the traffic light information acquisition part 124 may communicate with traffic lights present around the host vehicle M via the communication device 20 instead of (or in addition to) the camera image, and acquire positional information of the traffic lights and information related to the colors of the traffic lights that are lit in. That is, the traffic light information acquisition part 124 can acquire information related to the lit color of the traffic lights based on the camera image captured by the camera 10 installed in the host vehicle M or information received by the communication device 20 that communicates with the traffic lights.

The state detection part 140 includes, for example, a driving operation detection part 142, and a driver state detection part 144. The driving operation detection part 142 detects a driving operation of the host vehicle M by the driver. For example, the driving operation detection part 142 detects the amount of operation or the presence or absence of operation of each operation device (for example, the steering wheel, accelerator pedal, and brake pedal) by the driver using the operation detection part provided in the driving operation device 80. In addition, the driving operation detection part 142 may detect the state of the driving operation of the driver by correlating it with the magnitude or change (increase or decrease) of the output from the vehicle speed sensor and the acceleration sensor included in the vehicle sensor 40. In addition, the driving operation detection part 142 may detect the state of the driving operation of the driver regarding the steering of the host vehicle M based on the magnitude and change of the output from the steering angle sensor and the steering angle speed sensor included in the vehicle sensor 40.

The driver state detection part 144 performs, for example, known image analysis processing on the image captured by the interior camera 70 and detects the state of the driver of the host vehicle M based on the image analysis results. The state of the driver is, for example, a state based on the driver's posture or line of sight. The state of the driver may include, for example, whether the driver is monitoring the surroundings or not. In addition, the state of the driver may include whether the driver can drive or not. For example, when it is determined from the image captured by the interior camera 70 that the driver is dozing off, it is determined that the driver is not in a state where he or she can drive (is in a state where he or she cannot drive).

The driving assistance part 160 performs driving assistance of the host vehicle M on the basis of the acquisition results of the acquisition part 120, the detection results of the state detection part 140, the driver's instruction by the HMI 30, or the like. The driving assistance may include driving assistance through manual driving by the driver of the host vehicle M, as well as driving assistance based on driving control (autonomous driving) that controls at least one of the steering and speed of the host vehicle M to drive the host vehicle M without the driver's driving operation. In addition, the driving control includes, for example, an adaptive cruise control system (ACC), a lane keeping assistance system (LKAS), an auto lane changing (ALC), and the like. In addition, the driving control may include controls that stop the host vehicle M in a safe position, such as on the shoulder of the road.

The driving assistance part 160 includes, for example, a determination part 162, a traveling control part 164, and the HMI control part 166. The HMI control part 166 is an example of “the notification control part.” The determination part 162 performs various determinations on the acquisition status, for example, information related to the location and lit color of traffic lights, obtained by the traffic light information acquisition part 124. In addition, the determination part 162 performs various determinations on the state of the driver detected by the state detection part 140. The function of the determination part 162 will be described in detail below.

The traveling control part 164 controls traveling of the host vehicle M on the basis of the determination results by the determination part 162. For example, the traveling control part 164 controls at least one of the steering and the speed of the host vehicle M on the basis of the determination results. For example, when the host vehicle M executes driving control, the traveling control part 164 generates a target trajectory that the host vehicle M will travel in the future based on the surrounding situations and control contents (for example, the type of driving control to be executed), and controls the traveling driving force output device 200, the brake device 210, and the steering device 220 so that the host vehicle M passes through the generated target trajectory at the scheduled time. The target trajectory includes, for example, a speed element. For example, the target trajectory is expressed as a sequence of points (trajectory points) that the host vehicle M should reach. The trajectory point is a point where the host vehicle M should reach for each predetermined traveling distance (for example, a few meters) based on the road distance, and separately, a target speed and target acceleration are generated as a part of the target trajectory for each predetermined sampling time (for example, a few tenths of a second). The trajectory point may be the position that the host vehicle M should reach at each predetermined sampling time. In this case, the information related to target speed and target acceleration is expressed as the interval between trajectory points.

For example, when executing lane maintenance control such as LKAS, the traveling control part 164 generates a target trajectory so that the host vehicle M travels in the center of the traveling lane. In addition, the traveling control part 164 generates a target trajectory that the host vehicle M will travel in the future along the traveling trajectory of the preceding vehicle when executing following control such as ACC, which travels behind the preceding vehicle while maintaining a position of a predetermined distance from the preceding vehicle.

In addition, during manual driving by the driver, the traveling control part 164 controls at least one of the steering and the speed of the host vehicle M based on the surrounding situations and the state of the driver, for example, to avoid collision with obstacles or to enable the host vehicle M to travel more safely, or causes the HMI control part 166 to execute notifications such as warning information to the driver. For example, the traveling control part 164 executes at least speed control according to the acquisition status of the traffic lights, such as their position and lighting color information, provided by the traffic light information acquisition part 124. Further, the speed control may include not only acceleration control or deceleration control, but also acceleration suppression (not accelerating or reducing the proportion of acceleration to driving operations). The function of the traveling control part 164 will be described below in detail.

The HMI control part 166 notifies the occupant (including the driver) of predetermined information via the HMI 30 and accepts information input via the HMI 30. The predetermined information includes information related to the driving of the host vehicle M, such as information related to the state of the host vehicle M or information related to driving control. The information related to the state of the host vehicle M includes, for example, the speed, engine RPM, and shift position of the host vehicle M. In addition, the information related to driving control includes, for example, whether or not driving control (traveling control) is being executed according to the driving assistance part 160, information related to the execution status of driving control, information related to driving control recommendations (proposals) from the side of the system, and notification information (alarms, etc.) for the driver. In addition, the predetermined information may include information related to the surrounding situations recognized by the detection device DD. In addition, the predetermined information may include information unrelated to the traveling of the host vehicle M, such as television programs, contents (for example, videos) stored on a storage medium such as a DVD, etc. In addition, the predetermined information may include, for example, information regarding the current position or destination of the host vehicle M, and the remaining fuel level of the host vehicle M. The HMI control part 166 may output the information received by the HMI 30 to the communication device 20, the navigation device 50, the acquisition part 120, the state detection part 140, the driving assistance part 160, etc.

In addition, the HMI control part 166 may generate information showing the acquisition results by the acquisition part 120, the detection results by the state detection part 140, the determination results by the determination part 162, and the like, and output the generated information to the HMI 30. The generated information includes images and sounds (including notification sounds). In addition, the HMI control part 166 may transmit various information to be output by the HMI 30 via the communication device 20 to a terminal device (for example, a smartphone or tablet terminal) used by the occupant of the host vehicle M.

The traveling driving force output device 200 outputs the traveling driving force (torque) to the driving wheel for the host vehicle to travel. The traveling driving force output device 200 includes, for example, a combination of an internal combustion engine, an electric motor, and a transmission, and an electronic control unit (ECU) that controls these. The ECU controls the above configuration according to information input from the traveling control part 164 or information input from the accelerator pedal of the driving operation device 80.

The brake device 210 includes, for example, a brake caliper, a cylinder configured to transmit a hydraulic pressure to the brake caliper, an electric motor configured to generate a hydraulic pressure in the cylinder, and a brake ECU. The brake ECU controls the electric motor according to the information input from the traveling control part 164 or the information input from the brake pedal of the driving operation device 80, so that the brake torque corresponding to the braking operation is output to each wheel. The brake device 210 may be provided with a backup mechanism that transmits the hydraulic pressure generated by operating the brake pedal to the cylinder via the master cylinder. Further, the brake device 210 is not limited to the configuration described above, but may be an electronically controlled hydraulic brake device that controls the actuator according to the information input from the driving assistance part 160 and transmits the hydraulic pressure of the master cylinder to the cylinder.

The steering device 220 includes, for example, a steering ECU, and an electric motor. The electric motor, for example, exerts a force on a rack and pinion mechanism to change an orientation of a steered wheel. The steering ECU drives the electric motor to change the orientation of the steered wheels according to the information input from the traveling control part 164 or the information input from the steering wheel of the driving operation device 80.

### Driving Assistance Part

Next, driving assistance by the driving assistance part 160 (mainly, the determination part 162, the traveling control part 164) of the embodiment will be described in detail. In addition, in the following example, the description will mainly focus on driving assistance according to the acquisition status of the information related to the traffic lights. In addition, hereinafter, the description will mainly focus on driving assistance related to speed control, but driving assistance using steering control may also be provided instead of (or in addition to) speed control.

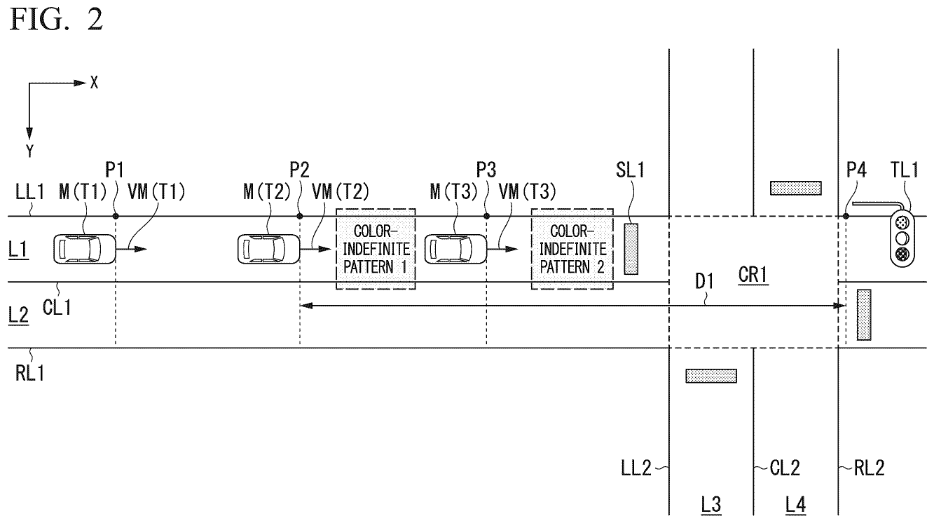

FIG. 2 is a view showing an example of a scene where the driving assistance of the embodiment is executed. In the example of FIG. 2, a lane (traveling lane) L1 in which the host vehicle M travels, a lane adjacent to the lane L1 (the oncoming lane in FIG. 2) L2, and lanes L3 and L4 that intersect (at-grade crossing) with the lanes L1 and L2 (connected at the intersection CR1) are shown. The lane L1 is defined by markings LL1 and CL1, and the lane L2 is defined by markings CL1 and RL1. In addition, a lane L3 is defined by markings LL2 and CL2, and a lane LA is defined by markings CL2 and RL2.

In FIG. 2, the host vehicle M is traveling on the lane L1 at a speed VM toward an intersection CR1. In addition, in FIG. 2, on the road surface of the lane L1, there is a stop line SL1 just before the intersection CR1 as seen from the host vehicle M. In addition, further away from the intersection CR1 as seen from the host vehicle M, there are traffic lights TL1 that display information (signals) to the host vehicle M traveling on the lane L1 indicating whether or not it is permitted to pass through the intersection CR1. In addition, in the example of FIG. 2, the position and speed of the host vehicle M at time T* are expressed as M(T*) and VM(T*), respectively. That is, in FIG. 2, the position and speed of the host vehicle M at time T1 are expressed as M(T1) and VM(T1), the position and speed of the host vehicle M at time T2 are expressed as M(T2) and VM(T2), and the position and speed of the host vehicle M at time T3 are expressed as M(T3) and VM(T3). In addition, in the following description, it is assumed that time T1 is the earliest, followed by times T2 and T3 in that order.

For example, the host vehicle M acquires surrounding information of the host vehicle M (for example, information in the direction of advance (forward) of the host vehicle M) through the acquisition part 120, and executes driving assistance for the host vehicle M through the driving assistance part 160 based on the acquired information.

In the example of FIG. 2, the time T1 (when the host vehicle M arrives at point P1) is the time when the host vehicle M acquires information that the intersection CR1 is in the direction of advance of the host vehicle M. Further, the host vehicle M travels toward the intersection CR1, and at time T2 (when the host vehicle M reaches point P2), the position of the traffic lights TL1 present near the intersection CR1 is acquired for the host vehicle M traveling in the lane L1. Further, the traffic lights TL1 are traffic lights that output (light up) information (signals) to the host vehicle traveling in the lane L1 indicating whether or not the host vehicle can pass through the intersection CR1. When a distance D1 from the current position of the host vehicle M to the position of the traffic lights TL1 is less than the predetermined distance, the traffic light information acquisition part 124 acquires information on the color in which the traffic lights TL1 are lit. The predetermined distance may be, for example, a fixed distance, or a variable distance that is set depending on the speed VM of the host vehicle M, a road shape, etc. Further, in the embodiment, the acquisition timing of the position of the traffic lights TL1 and the acquisition timing of the color of the traffic lights TL1 may be simultaneous, or the position may be acquired after the color of the traffic lights TL1 is acquired.

Then, the driving assistance part 160 executes driving assistance for the host vehicle M based on the acquisition status of the surrounding information of the host vehicle M. The driving assistance includes driving assistance for driving controls such as the LKAS and ACC described above, and driving assistance for the driving operation of the driver of the host vehicle M.

Here, when the traffic light information acquisition part 124 acquires information on the lit color of the traffic lights TL1, the lit color may become indefinite (color-indefinite state) due to some influences on the host vehicle M. The color-indefinite state includes cases where lighting cannot be detected, lighting is detected but the color type cannot be detected, and the color type is detected but the detected color is different from the predetermined (expected) color.

For example, when the host vehicle M is traveling at a position far from the intersection CR1 (or the traffic lights TL1) (for example, the segment from point P2 to point P3 (the segment from time T2 to T3) shown in FIG. 2), the distance from the traffic lights TL1 is far (longer than the predetermined distance), and the number of pixels of the traffic lights TL1 (or lamps) included in the camera image is small, so the color-indefinite state may occur (the above-mentioned pattern is referred to as “a color-indefinite pattern 1”).

In addition, the color-indefinite state may also occur even when the host vehicle M is traveling in a position closer to the intersection CR1 (or the traffic lights TL1) than in the state where the color-indefinite pattern 1 occurs (for example, the segment from point P3 to the intersection CR1 or the stop line SL1 (the segment after time T3) in FIG. 2). For example, this occurs when the distance from the traffic lights TL1 becomes closer (less than the predetermined distance) but is affected by disturbances such as sunlight or its reflected light shining on the lamps of the traffic lights TL1 or the camera 10, trees installed on the roadside obscuring the lamps of the traffic lights TL1, or a large vehicle (truck or bus) traveling ahead obscuring the lamps of the traffic lights TL1 from the host vehicle M (the above-mentioned pattern is referred to as “a color-indefinite pattern 2”).

Accordingly, in the embodiment, when the color-indefinite state occurs due to the color-indefinite patterns 1 and 2 described above, various controls are executed according to the acquisition status of the information related to the traffic lights TL1 to prevent incorrect driving assistance.

For example, the determination part 162 determines whether the traffic lights TL1 are present in the course of the lane in which the host vehicle M is traveling (the direction of advance (forward) of the host vehicle M) based on the acquisition results of the traffic light information acquisition part 124 or not. When it is determined that the traffic lights TL1 are present in the direction of advance of the host vehicle M, the determination part 162 determines whether the distance D1 between the host vehicle M and the traffic lights TL1 is within a predetermined distance or not.

When it is determined that the distance D1 from the host vehicle M to the traffic lights TL1 is less than the predetermined distance, the determination part 162 determines whether information on the color in which the traffic lights TL1 are lit has been acquired based on the acquisition results of the traffic light information acquisition part 124 or not. When it is determined that color information has not been obtained, the traveling control part 164 suppresses at least the acceleration of the host vehicle M.

In this case, the traveling control part 164 suppresses the acceleration of the host vehicle M, for example, by not accepting the driver's acceleration operation using the driving operation device 80 (more specifically, the accelerator pedal) or by not performing acceleration control in response to the received acceleration operation. In addition, the traveling control part 164 may suppress the acceleration rate by reducing the acceleration rate according to the received acceleration operation (operation amount) to a value less than normal. In addition, the traveling control part 164 may control the speed of the host vehicle M by regenerating a target trajectory that does not involve acceleration during execution of the driving control such as ACC and when the previously generated target trajectory includes an acceleration speed element. Further, the traveling control part 164 controls the speed of the host vehicle M according to the driver's operation instruction or target trajectory for speed operations other than acceleration operations (deceleration operations or constant speed operations).

In this way, when the information on the lit color of the traffic lights TL1 cannot be acquired, at least the acceleration of the host vehicle M can be suppressed to reduce the possibility of collision with an object near the traffic lights TL1 (for example, the intersection CR1). In addition, when color information cannot be acquired, instead of immediately performing deceleration control, acceleration suppression control is performed, thereby avoiding unnecessary braking (deceleration) when the color is indefinite, thereby reducing the discomfort felt by the user and stabilizing the behavior of the host vehicle M.

Further, the case (state) in which the color in which the traffic lights TL1 are lit has not been acquired may include, for example, the period from when it is acquired that the traffic lights TL1 are present based on the acquisition results of the traffic light information acquisition part 124 until when information on the color in which the traffic lights TL1 are lit is acquired. That is, the traveling control part 164 suppresses the acceleration of the host vehicle M until it acquires information on the lit color from the image analysis processing results of the camera image, or until it acquires information on the lit color from information received from the traffic lights TL1 via the communication device 20. Further, the above-mentioned phrase “from acquiring the existence of the traffic lights TL1” can be rephrased as “after acquiring the positional information of the traffic lights TL1.” Accordingly, for example, in the color-indefinite pattern 1, in a situation in which the host vehicle M is traveling a long distance from the intersection CR1 (the traffic lights TL1) and is unable to acquire color information, the execution of unnecessary controls such as deceleration can be suppressed, allowing for more appropriate driving assistance (speed control).

In addition, the determination part 162 determines the type of color acquired when it determines that information on the color that the traffic lights TL1 are lit has been acquired. For example, the determination part 162 determines whether the traffic lights TL1 are lit in blue or not. Here, blue is an example of a color that indicates that the host vehicle M traveling in the lane L1 is permitted to pass through the intersection CR1, and may be another predetermined color such as green. When the lit color is determined to be blue, the traveling control part 164 performs speed control (and/or steering control), such as acceleration or deceleration, depending on the driver's driving operation or a pre-generated target trajectory.

In addition, after it is determined that the traffic lights TL1 are lit in blue, for example, when it becomes impossible to acquire information on the lit color of the traffic lights TL due to the situation of the color-indefinite pattern 2 described above, the traveling control part 164 may suppress the acceleration of the host vehicle M. For example, even when the traffic lights TL1 are determined to be lit in blue at time T2 in FIG. 2, if the color of the traffic lights TL1 becomes indefinite due to disturbances or other factors when heading toward the intersection CR1 after time T3, there is a possibility that the color may have changed from blue to another color (the signal may have changed) during this indefinite period. For this reason, in the embodiment, in this situation, by suppressing at least the acceleration of the host vehicle M, the deceleration can be performed smoothly even when the traffic lights TL1 are switching lit colors, and the behavior of the host vehicle M can be stabilized. In addition, by controlling only acceleration suppression without immediately executing deceleration control using the above-mentioned information, unnecessary control when the color is indefinite due to disturbances, etc. can be suppressed. Accordingly, more appropriate driving assistance can be realized.

In addition, when it is determined that the lit color of the traffic lights TL1 is not blue, the determination part 162 determines whether the lit color of the traffic lights TL1 is red. Here, red is an example of a color that indicates that the host vehicle M traveling in the lane L1 is denied (not permitted) to pass through the intersection CR1 (or that it must stop before the stop line SL1), and other predetermined colors may also be used. In addition, the determination part 162 may determine whether the color is yellow instead of red. Yellow, like red, basically indicates that passage through the intersection CR1 is rejected.

When it is determined that the lit color is red (or yellow), the determination part 162 further determines whether the host vehicle M is decelerating due to the driver's driving operation or a pre-generated target trajectory (or whether the speed VM of the host vehicle M is less than the predetermined speed). When it is determined that the host vehicle M is not decelerating (or the speed VM of the host vehicle M is not less than the predetermined speed), the traveling control part 164 executes deceleration control so that the host vehicle M stops at a position before the stop line SL1. In addition, the traveling control part 164 may, instead of (or in addition to) the deceleration control described above, cause the HMI control part 166 to output an alarm or information that prompts deceleration. The HMI control part 166 generates images or sounds that indicate information that prompts an alarm or deceleration, and outputs the generated images and sounds to the HMI 30, thereby notifying the driver of the situation. In addition, when it is determined that the host vehicle M is decelerating (or the speed VM of the host vehicle M is less than the predetermined speed), the traveling control part 164 continues the current control.

In addition, after determining that lit color of the traffic lights TL1 is red (or yellow), when the information on the lit color of the traffic lights TL1 is no longer acquired, the traveling control part 164 may control the deceleration of the host vehicle M. For example, even when it is determined that the lit color of the traffic lights TL1 is red (or yellow) at time T2 in FIG. 2, if the color of the traffic lights TL1 becomes indefinite due to disturbances or other factors when heading toward the intersection CR1 from time T3 onwards, it is possible that the color may change from red (or yellow) to another color during this indefinite period, but since it is highly likely that the color will remain red, safer driving assistance can be provided by decelerating the host vehicle M.

Further, when the traveling control part 164 is unable to acquire information on the lit color that the traffic lights TL1 after determining that the lit color of the traffic lights TL1 is red (or yellow), and when the driving operation detection part 142 does not detect the driver's deceleration operation, or if the degree of deceleration operation being performed is less than a threshold, the traveling control part 164 may perform at least one of the deceleration of the host vehicle M and notification to the driver by the HMI control part 166. The deceleration steering degree being below the threshold includes, for example, when the driver operates the brake pedal but the speed VM of the host vehicle M is less than a predetermined speed, or when the pedaling amount of the brake pedal is less than a predetermined amount. In addition, notification to the driver by the HMI control part 166 includes, for example, notifying the driver of information that prompts further deceleration operation, or notifying the driver that the traffic lights TL1 ahead are red (the lit color of the traffic lights TL1 is red).

In addition, when the lit color of the traffic lights TL1 is determined to be neither blue nor red (or yellow), the traveling control part 164 may perform control to at least suppress acceleration. When it is unclear which color is lit, at least suppressing acceleration allows smooth deceleration control even when the light is red or yellow, making the behavior of the host vehicle M more stable.

In addition, the HMI control part 166 may vary the degree of notification depending on the distance from the host vehicle M to the traffic lights TL1 (the intersection CR1 or the stop line SL1) and/or the speed VM of the host vehicle M. For example, the HMI control part 166 displays an image showing information that prompts deceleration on the display part of the HMI 30 when the distance from the host vehicle M to the traffic light TL1 is equal to or greater than the threshold, and outputs an alarm sound from the speaker along with the image when the distance is less than the threshold. In addition, instead of (or in addition to) deceleration until the speed VM of the host vehicle M reaches a predetermined speed, deceleration control may be to increase the degree of deceleration in response to the driver's deceleration operation (in other words, to increase the deceleration even with a small amount of pedaling of the brake pedal). Accordingly, it is possible to provide more appropriate driving assistance in response to the driver's driving operation (especially deceleration operation).

### Variant

In the embodiment, the traveling control part 164 may not suppress the acceleration of the host vehicle M when the speed VM of the host vehicle M is less than the predetermined speed, even if the distance D1 from the host vehicle M to the traffic lights TL1 is less than the predetermined distance and information on the lit color of the traffic lights TL1 has not been acquired. For example, even in situations where the lit color of the traffic lights TL1 cannot be acquired from the camera image, the driver may be able to see the color of the traffic lights TL1 and perform acceleration operations, or may be performing acceleration operations in accordance with the behavior of surrounding vehicles, etc. Accordingly, by not suppressing the acceleration of the host vehicle M when the speed VM of the host vehicle M is less than the predetermined speed, unnecessary acceleration suppression can be suppressed, reducing discomfort to the user and enabling more appropriate driving assistance to be performed.

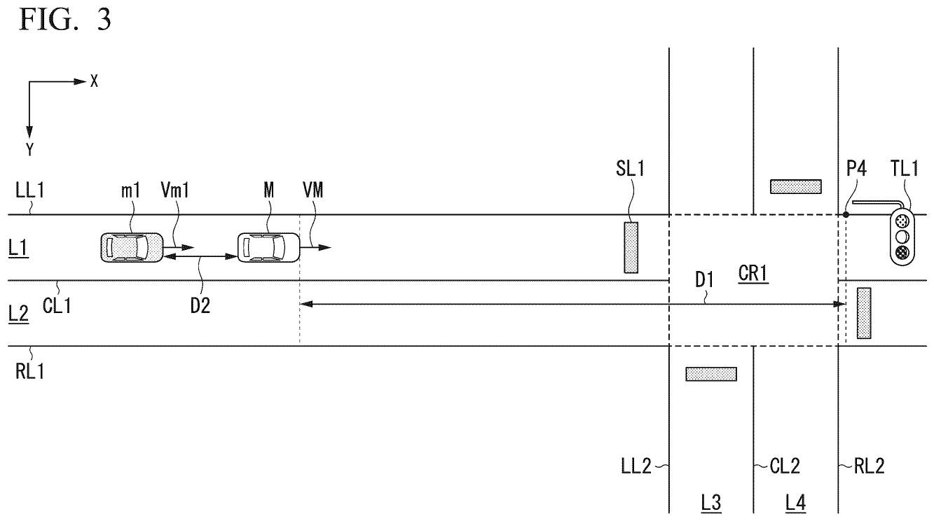

In addition, in the embodiment, the traveling control part 164 may be configured not to suppress the acceleration of the host vehicle M when the surrounding information acquisition part 122 acquires information on the following vehicle of the host vehicle M. FIG. 3 is a view showing an example of a screen in which the following vehicle is present around the host vehicle M. In the example of FIG. 3, under the same road conditions as in FIG. 2, the following vehicle m1 is traveling behind the host vehicle M on the lane L1 at a speed Vm1.

In the example of FIG. 3, the traveling control part 164 does not suppress the acceleration of the host vehicle M when the surrounding information acquisition part 122 determines that the following vehicle m1 is present behind the host vehicle M, even if the distance D1 from the host vehicle M to the traffic lights TL1 is less than the predetermined distance (first predetermined distance) and the traffic light information acquisition part 124 has not acquired information on the lit color of the traffic lights. Further, the traveling control part 164 may not suppress acceleration when a distance (relative distance) D2 between the host vehicle M and the following vehicle m1 is less than a predetermined distance (second predetermined distance), and may not suppress acceleration when a time to collision TTC between the host vehicle M and the following vehicle m1 is less than a threshold. The time to collision TTC is derived by, for example, dividing the relative distance (the distance D2) by the relative speed (the absolute value of “the speed VM-the speed Vm1”) between the host vehicle M and the following vehicle m1. Accordingly, collision with the following vehicle m1 can be suppressed by unnecessary acceleration suppression.

In addition, in the embodiment, when the driver state detection part 144 detects that the driver of the host vehicle M is in a forward monitoring state, the traveling control part 164 may not suppress the acceleration of the host vehicle M even if the distance D1 from the host vehicle M to the traffic lights TL1 is less than the predetermined distance and information on the lit color of the traffic lights TL1 has not been acquired. When the driver is looking ahead, there is a high possibility that the situations of surroundings (especially ahead) can be grasped. For this reason, in such a situation, by controlling the host vehicle M so that its acceleration is not suppressed, control can be executed according to the driver's intention, thereby reducing the user's discomfort and performing more appropriate driving assistance.

In addition, in the embodiment, the traveling control part 164 may control the host vehicle M not to suppress its acceleration based on the traveling situation of the adjacent vehicle acquired by the surrounding information acquisition part 122, even if the distance D1 from the host vehicle M to the traffic lights TL1 is less than the predetermined distance and the traffic light information acquisition part 124 has not acquired information on the lit color of the traffic lights.

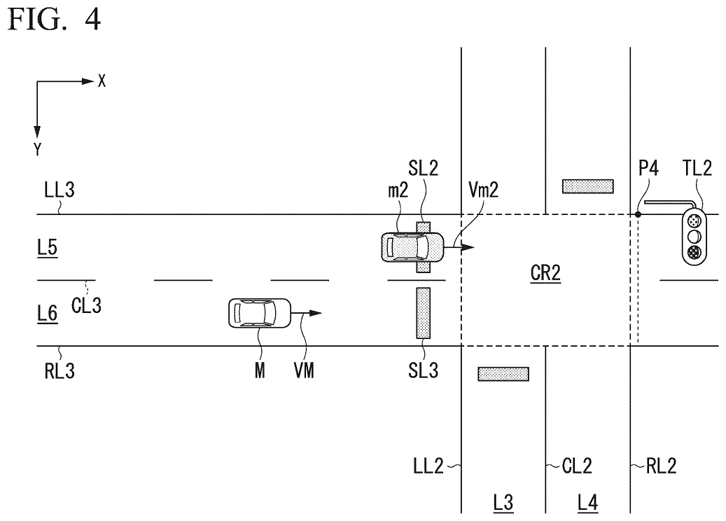

FIG. 4 is a view showing an example of a scene where the host vehicle M travels on a road shape that has a plurality of lanes that allow it to travel in the same direction. In the example of FIG. 4, lanes L5 and L6 intersecting (at-grade crossing) with lanes L3 and L4 (connecting at an intersection CR2) are shown. The lanes L5 and L6 are lanes that can move in the same direction (X-axis direction in FIG. 4). The lane L5 is defined by markings LL3 and CL3, and the lane L6 is defined by markings CL3 and RL3.

In the example of FIG. 4, the host vehicle M is traveling on the lane L6 toward the intersection CR2 at the speed VM. Accordingly, the lane L6 is the traveling lane of the host vehicle M, and the lane L5 is an adjacent lane to the lane L6. In the lane L5, the other vehicle m2 is traveling at a speed Vm2 toward the intersection CR2. The other vehicle m2 is an adjacent vehicle traveling in the adjacent lane to the traveling lane of the host vehicle M and is present within a predetermined distance from the host vehicle M. In addition, in the example of FIG. 4, further away from the intersection CR2 as seen from the host vehicle M, there are traffic lights TL2 that display information (signals) to the host vehicles traveling on the lanes L5 and L6 indicating whether or not they can pass through the intersection CR2. Further, the traffic lights TL2 are provided on the side of the lane L5 (side of the adjacent lane). In addition, in the lane L5, there is a stop line SL2 just before the intersection CR2 as seen from the host vehicle M, and in the lane L6, there is a stop line SL3 just before the intersection CR2 as seen from the host vehicle M.

For example, in a scene shown in FIG. 4, even if the distance D1 from the host vehicle M to the traffic lights TL1 is less than the predetermined distance and the traffic light information acquisition part 124 has not acquired information on the lit color of the traffic lights TL2, the traveling control part 164 does not suppress the acceleration of the host vehicle M when the surrounding information acquisition part 122 acquires that there is an adjacent lane L5 in which the host vehicle M can travel in the same direction as the traveling lane in which the host vehicle M is traveling, and that there is another vehicle (adjacent vehicle) m2 in the adjacent lane that is passing through the intersection CR2 in which the traffic lights TL2 are installed. For example, the other vehicle m2 is determined to be passing through the intersection CR2 when the position of the other vehicle m2 is entering the intersection CR2 side of the stop line SL2 in the adjacent lane L5, when it is passing through the intersection CR2, or when it is traveling at a predetermined speed or faster and less than the predetermined distance from the intersection CR2.

For example, even if the lit color of the traffic lights TL2 is indefinite from the position of the host vehicle M in the lane L6 due to external disturbances, etc., the angle of the traffic lights TL2 (the direction of the traffic lights as seen from the host vehicle) from the position of the other vehicle m2 traveling in the adjacent lane L5 is different from that of the host vehicle M, so it is highly likely that the lit color of the traffic lights TL2 can be seen from the other vehicle m2 without being affected by external disturbances, etc. (or the driver of the other vehicle m2 can see the lit color of the traffic lights TL2). For this reason, the traveling control part 164 can perform more appropriate driving assistance depending on the surrounding situations by not suppressing the acceleration of the host vehicle M when the other vehicle m2 traveling in the adjacent lane L5 is about to enter (or is traveling) the intersection CR2 at or above a predetermined speed.

In addition, in the embodiment, it is determined whether traffic lights are installed in predetermined road conditions, such as when there is a road shape such as an intersection or a crosswalk, and when the traffic lights are installed in the predetermined road conditions, various controls related to the driving assistance described above may be executed. In addition, in the embodiment, the speed control contents of the host vehicle M may be changed according to the road shape around the location where the traffic lights are installed. For example, the traveling control part 164 performs controls such as varying the degree of acceleration suppression and degree of deceleration depending on whether the road shape near the traffic lights is an intersection or whether there is a crosswalk on the road near the traffic lights.

In addition, in the embodiment, the execution of the above-mentioned acceleration suppression and deceleration control may be controlled according to the time period. For example, situations where the lit color of traffic lights becomes indefinite due to the influence of sunlight, etc. are unlikely to occur at night, and the possibility of them becoming invisible is low. Accordingly, based on the location and installation direction of the traffic lights, a time period during which the lit color is predicted to be indefinite may be set, and the above-mentioned control may be performed when passing near those traffic lights during the set time period.

In addition, when the lit color of the traffic lights is not a preset color (blue, yellow, red), the traffic light information acquisition part 124 may infer the lit color based on which lamp among the plurality of lamps (lighting parts) arranged in the traffic lights is lit. Since the lit color arrangement of traffic light lamps is determined according to preset criteria, by acquiring the position of the lit lamp among the plurality of lamps installed in the traffic lights, it is possible to infer the lit color, and more appropriate driving assistance can be performed depending on the inferred color.

In addition, a flickering traffic light lamp may have a different meaning than when the lamps are lit. For example, a flickering yellow light means the driver should proceed with caution, while a flickering red light means the driver should stop at the stop sign and check that it is safe before proceeding. Accordingly, the determination part 162 may, for example, determine whether the lit color is yellow or red and whether the color is flickering or not. In addition, the traveling control part 164 may execute different control (for example, control of making degree of acceleration suppression or degree of deceleration different) when the light is flickering from when the light is on.

### Processing Flow

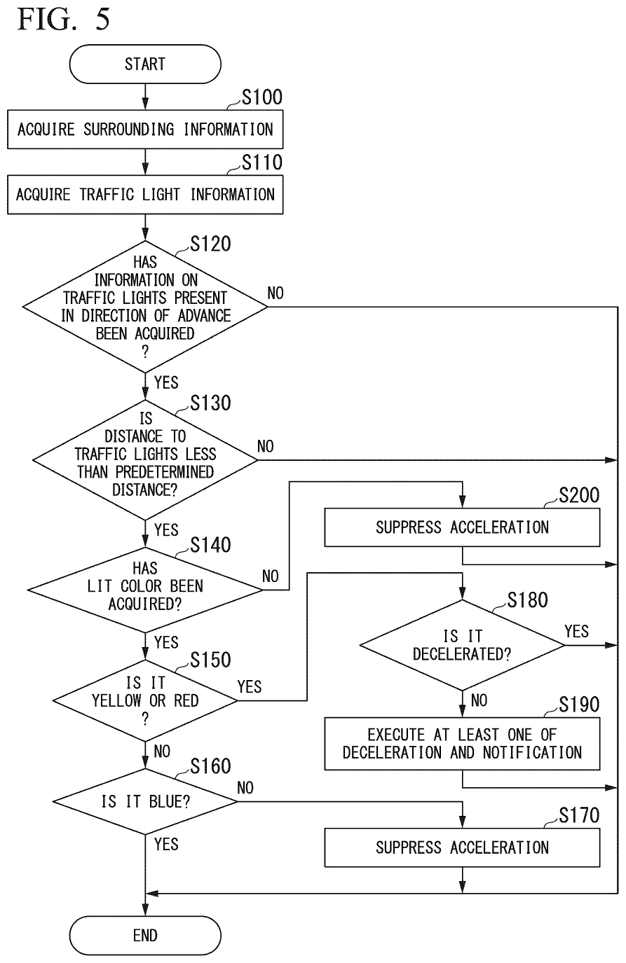

Next, processing executed by the driving assistance device 100 of the embodiment will be described. FIG. 5 is a flowchart showing an example of the processing executed by the driving assistance device 100. Further, hereinafter, in the processing executed by the driving assistance device 100, processing that perform driving control for the host vehicle M on the basis of the information from the traffic lights will be mainly described. In addition, the processing described below may be executed repeatedly with a predetermined period or timing.

In the example of FIG. 5, the surrounding information acquisition part 122 acquires surrounding information of the host vehicle M (step S100). Next, the traffic light information acquisition part 124 acquires of information of traffic lights that are present around the host vehicle M (step S110). Next, the determination part 162 determines whether the host vehicle M has acquired information on the traffic lights present in its direction of advance (the course of the lane in which the host vehicle is traveling) (step S120). When it is determined that the traffic light information has been detected, the determination part 162 determines whether the distance from the host vehicle M to the traffic lights is less than a predetermined distance (step S130). When it is determined that the distance is less than the predetermined distance, the determination part 162 determines whether the lit color of the traffic lights has been acquired (step S140).

When it is determined that the lit color has been acquired, the determination part 162 determines whether the lit color of the traffic lights is yellow or red (step S150). When it is determined that the lit color is not yellow or red, the determination part 162 determines whether the lit color is blue (step S160). When it is determined that the light is not blue, since the light is acquired in a color other than the predetermined color, the traveling control part 164 performs control to suppress the acceleration of the host vehicle M (step S170). Further, in the processing of step S170, instead of (or in addition to) the control that suppresses the acceleration of the host vehicle M, the control that decelerates the host vehicle M may be performed, in which case a notification control may be performed that notifies the driver of predetermined information via the HMI control part 166. In addition, when it is determined to be blue, the processing of the flowchart is terminated.

In addition, in the processing of step S150, when it is determined that the lit color of the traffic lights yellow or red, the determination part 162 determines whether the host vehicle M is decelerating (step S180). When it is determined that deceleration has not occurred, the traveling control part 164 executes at least one of deceleration and notification control by the HMI control part 166 (step S190), and terminates the processing of the flowchart. In addition, in the processing of step S190, when it is determined that deceleration is occurring, the processing of the flowchart is terminated.

In addition, in the processing of step S140, when it is determined that the lit color has not been acquired, the traveling control part 164 suppresses at least the acceleration of the host vehicle M (step S200), and terminates the processing of the flowchart.

In addition, in the processing of step S120, the processing of the flowchart is terminated when it is determined that information on traffic lights present in the direction of advance has not been acquired, or in the processing of step S130, when it is determined that the distance to the traffic lights is not less than the predetermined distance.

According to the above-mentioned embodiment, the driving assistance device 100 includes the surrounding information acquisition part 122 configured to acquire surrounding information of the host vehicle M, the traffic light information acquisition part 124 configured to acquire positional information and lighting status of traffic lights present around the host vehicle M on the basis of the positional information of the host vehicle M, and the driving assistance part 160 configured to perform driving assistance of the host vehicle M on the basis of the acquisition results of the surrounding information acquisition part 122 and the traffic light information acquisition part 124, and the driving assistance part 160 suppresses the acceleration of the host vehicle M when the distance from the host vehicle M to the traffic lights on the course of the lane in which the host vehicle M is traveling is less than the predetermined distance, and the traffic light information acquisition part 124 has not acquired information on the lit color of the traffic lights, thereby performing more appropriate driving assistance depending on the acquisition status of the information regarding the traffic lights.

For example, according to the embodiment, unnecessary deceleration control can be suppressed in situations where recognition accuracy of the camera is reduced due to the distance between the host vehicle M and the traffic lights or external disturbances, or where the color of the traffic lights is indefinite due to poor communication with the communication device 20. For this reason, it is possible to reduce the instability of vehicle behavior caused by sudden deceleration, allowing for more appropriate driving assistance to be performed depending on the situation. In addition, according to the embodiment, when the color of the traffic lights becomes indefinite, unnecessary braking can be suppressed, and inappropriate acceleration operations by the driver can also be suppressed.

The above-mentioned embodiment can be expressed as follows.

A driving assistance device including:
a storage medium configured to store instructions readable by a computer (computer-readable instructions), and
a processor connected to the storage medium,
the processor executing the computer-readable instructions to:
acquire surrounding information of a host vehicle;
acquire positional information and lighting status of traffic lights present around the host vehicle on the basis of positional information of the host vehicle;
perform driving assistance of the host vehicle on the basis of the acquired information; and
suppress acceleration of the host vehicle when a distance from the host vehicle to the traffic lights in the course of the lane in which the host vehicle is traveling is less than a predetermined distance, and information on the lit color of the traffic lights has not been acquired.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A driving assistance device comprising:
a storage medium storing computer-readable instructions; and
at least one processor connected to the storage medium,
wherein the processor executes the computer-readable instructions to:
acquire surrounding information of a host vehicle;
acquire positional information and lighting status of traffic lights present around the host vehicle on the basis of positional information of the host vehicle;
perform driving assistance of the host vehicle on the basis of the acquired information, and
suppress acceleration of the host vehicle when a distance from the host vehicle to the traffic lights in a course of a lane in which the host vehicle is traveling is less than a predetermined distance, and information on lit color of the traffic lights has not been acquired.

2. The driving assistance device according to claim 1, the processor executes the computer-readable instructions to:
detect a driving operation by a driver of the host vehicle, and
suppress acceleration of the host vehicle due to the driver's acceleration operation when the distance from the lane to the traffic lights in the course of the lane in which the host vehicle is traveling is less than the predetermined distance and information on the lit color of the traffic lights has not been acquired.

3. The driving assistance device according to claim 2, wherein the case where the color of the traffic lights has not been acquired includes a period from when existence of the traffic lights is acquired based on the acquired information until when information on the lit color of the traffic lights has been acquired.

4. The driving assistance device according to claim 2, the processor executes the computer-readable instructions to:
suppress acceleration of the host vehicle when it is unable to acquire information on the lit color of the traffic lights after acquiring that the lit color of the traffic lights is blue.

5. The driving assistance device according to claim 2, the processor executes the computer-readable instructions to:
decelerate the host vehicle when it is unable to acquire information on the lit color of the traffic lights after acquiring that the lit color of the traffic lights is red or yellow.

6. The driving assistance device according to claim 5, the processor executes the computer-readable instructions to:
perform at least one of notification to the driver and deceleration of the host vehicle when it is acquired that the lit color of the traffic lights is yellow or red, and acquire that the driver's deceleration operation has not been detected or the degree of deceleration operation is less than a threshold.

7. The driving assistance device according to claim 1, the processor executes the computer-readable instructions to:
not suppress the acceleration of the host vehicle when a speed of the host vehicle is less than a predetermined speed.

8. The driving assistance device according to claim 1, the processor executes the computer-readable instructions to:
not suppress the acceleration of the host vehicle when information on a following vehicle around the host vehicle is acquired.

9. The driving assistance device according to claim 1, the processor executes the computer-readable instructions to:
detect the driver's state of the host vehicle,
not suppress the acceleration of the host vehicle when it is detected that the driver is in a state where the driver is monitoring the front.

10. The driving assistance device according to claim 1, the processor executes the computer-readable instructions to:
not suppress acceleration of the host vehicle when it is acquired that there is an adjacent lane adjacent to the lane in which the host vehicle is traveling and able to travel in the same direction as the lane, and there is another vehicle passing through an intersection where the traffic lights are installed in the adjacent lane.

11. The driving assistance device according to claim 1, the processor executes the computer-readable instructions to:
acquire information on the lit color of the traffic lights based on an image captured by a camera installed in the host vehicle or information received by a communication device that communicates with the traffic lights.

12. A driving assistance method of causing a computer to:
acquire surrounding information of a host vehicle;
acquire positional information and lighting status of traffic lights present around the host vehicle on the basis of positional information of the host vehicle;
perform driving assistance of the host vehicle on the basis of the acquired information; and
suppress acceleration of the host vehicle when a distance from the host vehicle to the traffic lights in a course of a lane in which the host vehicle is traveling is less than a predetermined distance, and information on lit color of the traffic lights has not been acquired.

13. A computer-readable non-transient storage medium, on which a program is stored, causing a computer to:
acquire surrounding information of a host vehicle;
acquire positional information and lighting status of traffic lights present around the host vehicle on the basis of positional information of the host vehicle;
perform driving assistance of the host vehicle on the basis of the acquired information; and
suppress acceleration of the host vehicle when a distance from the host vehicle to the traffic lights in a course of a lane in which the host vehicle is traveling is less than a predetermined distance, and information on lit color of the traffic lights has not been acquired.
